(19) United States
(12) Patent Application Publication
(10) Pub. No.: US 2004/0148632 A1
(43) Pub. Date: Jul. 29, 2004

(54) Remote controller and set-top-box therefor

(76) Inventors: Ji-Hyun Park, Seoul (KR); Kyong-Joon Chun, Seoul (KR); Nak-Koo Kim, Seongnam-city (KR)

Correspondence Address: Robert E. Bushnell, Suite 300, 1522 K Street, N.W., Washington, DC, 20005, US

(21) Appl. No.: 10/749,385

(22) Filed: Jan. 2, 2004

(30) Foreign Application Priority Data
Jan. 23, 2003 (KR) 4643/2003

(51) Int. Cl. H04N 7/173; H04N 7/16; H04N 7/18; H04N 5/44

(52) U.S. Cl. 725/81; 725/80; 725/133; 725/141; 348/734

(57) ABSTRACT

An integrated remote controller and a main set-top-box therefor, wherein the integrated remote controller performs communication with the main set-top-box of home network system through WLAN and provides appliance control signals to a corresponding appliances connected to the main set-top-box through wires or wirelessly. Every home networked household appliance can be controlled by one integrated remote controller through intuitive and easy user interface, irrespective of where a user is, whereby the user can easily control any appliance, check a control result in response to a control request right away, and check or control the status of appliances through a regular monitoring function. As a result, user mobility, convenience, and functionality can be maximized.

### CLAIM OF PRIORITY

This application makes reference to, incorporates the same herein, and claims all benefits accruing under 35 U.S.C. §119 from an application for “REMOTE CONTROLLER AND SET-TOP-BOX THEREFOR”, earlier filed in the Korean Intellectual Property Office on 23 Jan. 2003 and there duly assigned Serial No. 2003-4643.

### BACKGROUND OF THE INVENTION

1. Technical Field

The present invention relates to a remote controller and a set-top-box therefor, and more particularly, relates to a remote controller and set-top-box used to control a plurality of devices.

2. Related Art

Now it is becoming more common for high speed Internet services to be provided to residences. Also, data can now be transmitted to and from those residences at very high transmission speeds. Due in part to these developments, more people are expressing an interest in home network systems.

Home network systems can be helpful if they are easy to set up and use, and if they provide a user with a significant level of control over a large number of devices in the home. However, some home network systems are inconvenient because they do not allow a user to easily control many devices and appliances in the home. Efforts have been made to facilitate operation and connection of devices in the home.

Exemplars of recent efforts relating to operating and/or connecting devices in the home are disclosed, for example, in U.S. Pat. No. 6,526,581 to Edson, entitled MULTI-SERVICE IN-HOME NETWORK WITH AN OPEN INTERFACE, issued on Feb. 25, 2003, U.S. Pat. No. 6,202,210 TO Ludtke, entitled METHOD AND SYSTEM FOR COLLECTING DATA OVER A 1394 NETWORK TO SUPPORT ANALYSIS OF CONSUMER BEHAVIOR, MARKETING AND CUSTOMER SUPPORT, issued on Mar. 13, 2001, and U.S. Pat. No. 5,410,326 to Goldstein, entitled PROGRAMMABLE REMOTE CONTROL DEVICE FOR INTERACTING WITH A PLURALITY OF REMOTELY CONTROLLED DEVICES, issued on Apr. 25, 1995.

While these contemporary efforts contain value, further improvements can also be contemplated.

### SUMMARY OF THE INVENTION

The present invention provides an integrated remote controller and a set-top-box therefor. The remote controller allows a user to remotely control a plurality of appliances without regard to location of the user, because of a wireless local area network (WLAN) in a home network system.

The present invention provides a set-top-box for an integrated remote controller in a home network system, including: an internal communication interface connected to at least one of appliances to compose home network through wires or wirelessly, for performing communication with each appliance; a wireless local area network (WLAN) interface connected through WLAN, for performing communication with an integrated remote controller to control each of the appliance at a remote site; and a controller for receiving an appliance control signal from the integrated remote controller through the WLAN interface and controlling a corresponding appliance through the internal communication interface.

Another aspect of the present invention provides an integrated remote controller for home network system, including: a wireless local area network (WLAN) interface for performing communication through WLAN with a set-top box that is connected to at least one of appliances to compose home network through wires or wirelessly; a command input unit for inputting a command to control an arbitrary appliance of the home networked appliances; and a controller for transmitting an appliance control signal, in response to an input command through the command input unit, to the set-top-box through the WLAN interface to be able to control a corresponding appliance being connected to the set-top-box through wires or wirelessly.

In accordance with the principles of the present invention, as embodied and broadly described, the present invention provides a main control unit for a home network system, the main control unit comprising: a communication interface communicating with at least one device; a wireless interface communicating wirelessly with a remote control unit, the remote control unit being separately located from the main control unit; and a controller receiving control signals from the remote control unit through said wireless interface, said controller controlling the at least one device through said communication interface in dependence upon the control signals.

In accordance with the principles of the present invention, as embodied and broadly described, the present invention provides a remote control unit for a home network system, the remote control unit comprising: a wireless interface communicating wirelessly with a main control unit; a command input unit inputting a command to control at least one device in communication with the main control unit; and a controller transmitting a wireless control signal to the main control unit through said wireless interface to control the at least one device in dependence upon the command inputted at said command input unit.

In accordance with the principles of the present invention, as embodied and broadly described, the present invention provides a home network system, comprising: a remote control II unit, comprising: a first wireless interface communicating wirelessly; a command input unit inputting a command to control at least one device; and a first controller wirelessly transmitting a control signal through said first wireless interface, the control signal corresponding to the command; and a main control unit being separately located from said remote control unit, said main control unit comprising: a communication interface communicating with the at least one device; a second wireless interface communicating wirelessly with said first wireless interface, said second wireless interface receiving the control signal from said first wireless interface; and a second controller controlling the at least one device through said communication interface in dependence upon the control signal received at said second wireless interface.

The present invention is more specifically described in the following paragraphs by reference to the drawings attached only by way of example. Other advantages and features will become apparent from the following description and from the claims.

### BRIEF DESCRIPTION OF THE DRAWINGS

In the accompanying drawings, which are incorporated in and constitute a part of this specification, embodiments of the invention are illustrated, which, together with a general description of the invention given above, and the detailed description given below, serve to exemplify the principles of this invention, wherein:

FIG. 1 is a schematic diagram of an embodiment of a home network system, in accordance with the principles of the present invention;

FIG. 2 is a schematic unit diagram of the home network system of FIG. 1, in which components of the system are arrayed in interfaces, in accordance with the principles of the present invention;

FIG. 3 is a diagram illustrating a detailed configuration of a set-top-box shown in FIG. 2, in accordance with the principles of the present invention;

FIG. 4 is a unit diagram of an embodiment of a remote controller, in accordance with the principles of the present invention;

FIG. 5 is a unit diagram of an embodiment of a remote controller, in accordance with the principles of the present invention;

FIG. 6 diagrammatically illustrates a screen being displayed on a display unit of the remote controller, in accordance with the principles of the present invention; and

FIG. 7 illustrates a screen being displayed on a display unit of the remote controller, in accordance with the principles of the present invention.

### DESCRIPTION OF BEST MODE OF CARRYING OUT THE INVENTION

While the present invention will be described more fully hereinafter with reference to the accompanying drawings, in which details of the present invention are shown, it is to be understood at the outset of the description which follows that persons of skill in the appropriate arts may modify the invention here described while still achieving the favorable results of this invention. Accordingly, the description of the best mode contemplated of carrying out the invention, which follows, is to be understood as being a broad, teaching disclosure directed to persons of skill in the appropriate arts, and not as limiting upon the present invention.

Illustrative embodiments of the best mode of carrying out the invention are described below. In the interest of clarity, not all features of an actual implementation are described. In the following description, well-known functions, constructions, and configurations are not described in detail since they could obscure the invention with unnecessary detail. It will be appreciated that in the development of any actual embodiment numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill having the benefit of this disclosure.

It would be desirable to have a home network system with one terminal that allows a user to remotely control and operate numerous household devices and appliances, that also allows a user to access the Internet at very high data transmission rates, and that additionally allows a user to control the reception of high definition digital television (HDTV) broadcasts and video on demand (VOD) services.

Each appliance in such a home network system basically allows users to get various services at a remote site through the use of a simple wireless remote controller also known as a remote controller, a remote control unit, or a remote control. One simple remote controller can enable users to have one-way wireless communication with a controlled object at a remote site 38 kilohertz (kHz) band infrared (IR). A simple remote controller can have number key buttons and other functional buttons, which a user selects to control functions of a controlled object at a remote site. For example, in the case of a television, the simple remote controller can be used to control channel, volume, brightness, mute, channel memory, and other functions.

A simple remote controller can use “AAA” size battery cells and operate within an operation range of 5 megahertz (MHz) with an operation angle of ±30 degrees (°), for example. When a user controls objects in a remote site using the simple remote controller, it is necessary to differentiate frequencies for each controlled object to prevent errors in the transmitted/received data. Thus, several simple remote controllers can be needed to control different devices, because each object/controller pair has different frequencies.

For example, when a user purchases a television, there will probably be a simple remote control unit included. That remote control unit transmits the particular frequencies that will allow a user to remotely change the channel and the volume of that television. Later, when the user purchases a video cassette recorder (VCR), there will probably be a second remote control unit included, and that second remote control unit can be used only to control functions of the video cassette recorder. The video cassette recorder (VCR) is also known as a video tape recorder (VTR). Since the frequencies are not standardized, the user cannot use only one of those two remote control units to operate both the television and the video cassette recorder. Instead, the user needs to use the first remote control unit to control the television, and the user needs to use the second remote control unit to control the video cassette recorder. When the user buys a digital versatile disc (DVD) player with a third remote control unit, and then some audio equipment that comes with its own (fourth) remote control unit, the number of remote control units quickly increases. In the above example, each one of the numerous remote control units is compatible with one and only one device. This can be cumbersome and inconvenient for a user.

Also, in some cases, there is a password between a remote controller and a controlled object. In other words, in some cases, there is a password that is needed for communication between a remote control unit and the device that is controlled by the remote control unit. If the designated password is changed or deleted, it becomes impossible to transmit data between the remote controller and controlled object.

As such, these types of simple remote controllers do not provide users with many options other than a simple one-sided control over household appliances. Since each household appliance requires its corresponding remote controller, using a plurality of remote controllers is rather inevitable. Thus, in reality, this type of home network system would not satisfy the various demands and convenience of users.

As an attempt to overcome the above weaknesses, a remote controller might be designed to for a set-top-box. Such a remote control unit/set-top-box pair might enable a user to change the volume on the television and on the audio equipment, for example, which would be more convenient than needing two remote control units. Unfortunately, however, the remote control unit and set-top-box might require a complicated set up procedure that is bothersome and inconvenient. Furthermore, the remote control unit and set-top-box might not completely solve the problem described above, where a user needs multiple remote control units, because the remote control unit for the set-top-box is only for one-way communication and also because the individual remote control units may offer special functions that are not available through the set-top-box. For example, the television's individual remote control unit may offer a special feature such as a special channel scan function, but the generic remote control unit for the set-top-box unit might not offer that special channel scan function. Thus, in this example, the user would still have to use multiple remote control units on at least some occasions, such as when that user wants to utilize the special channel scan function.

Even when users believe they are able to control a corresponding appliance with a remote control unit, sometimes it might not be easy to know the actual operation results. For example, when a user sends a signal to “turn off the DVD player”, the user might not be sure that the signal was received and performed. Therefore, reliability and functionality of this type of home network system is not something that would satisfy all users.

Other home network systems could be developed that would require a mouse or keyboard, and would require that a user look at specific screens for specific objects, and these factors tend to reduce mobility and convenience of such a home network system.

An improvement would be a two-way remote controller that sends control signals and also receives responses. However, a designer might choose to offer such a two-way remote controller with a limitation in that it provides only partial bidirectional control of appliances. Also, when a user wants to control other household appliances at remote sites away from the present position, the aforementioned two-way remote controller may require a master that reads remote control commands provided by the user and gives appropriate commands to appliances the user wanted to control. For these reasons, many users are becoming discouraged and are now decreasing their interest in home network systems.

The following detailed description will present an integrated remote controller and a set-top-box therefor according to a preferred embodiment of the invention in reference to the accompanying drawings. An improved and convenient home network system, with the remote controller and set-top-box of the present invention, can offer many advantages over other home network systems.

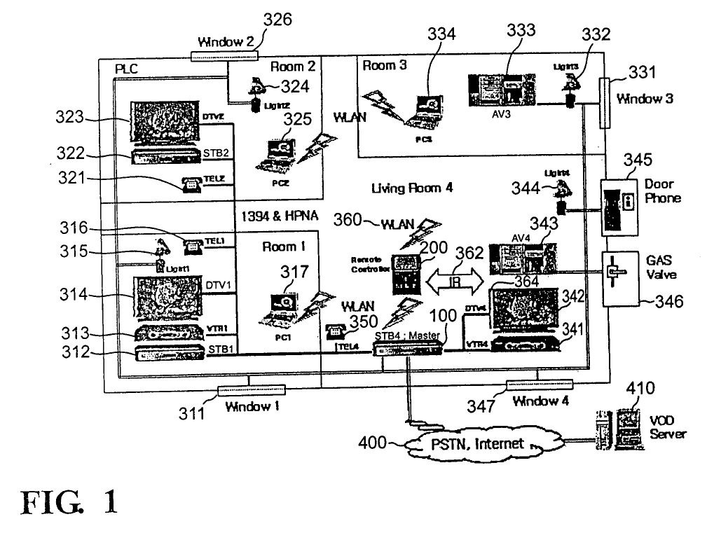

FIG. 1 is a schematic diagram of an embodiment of a home network system, in accordance with the principles of the present invention. Referring to FIG. 1, the home network system of the present invention includes numerous devices 311 through 350 installed in the rooms. Also, the home network system includes a master set-top-box 100 connected to each of the devices wirelessly or through wires. Furthermore, the home network system includes a remote controller 200 for controlling each device remotely, from a distance, by performing communication through the set-top-box 100 and the wireless local area network (WLAN). The remote controller 200 can also be referred to as a remote control unit 200.

As shown in FIG. 1, each room has home networked devices or appliances. For example, room 1 has a window 1 (311) and a sub set-top-box (STB) 1 (312). The room 1 also includes a video tape recorder (VTR) 1 (313). The room 1 also has a digital television (DTV) 1 (314), a light 1 (315), a telephone (TEL) 1 (316), and a wireless personal computer (PC) 1 (317).

The room 2 has a telephone (TEL) 2 (321), a sub set-top-box (STB) 2 (322), and a digital television (DTV) 2 (323). The room 2 also has a light 2 (324), a wireless personal computer (PC) 2 (325), and a window 2 (326).

The room 3 has a window 3 (331) and a light 3 (332). The room 3 also has audio/video (ANV) equipment labeled as AV3 (333) and a wireless personal computer (PC) 3 (334).

The living room 4 has video tape recorder (VTR) 4 (341) and a digital television (DTV) 4 (342). The living room 4 also has audio/video (A/V) equipment labeled as AV4 (343) and a light 4 (344). The living room 4 also has a communication device 345 that is useful when an unexpected guest knocks on the front door. This communication device 345 can be referred to as an intercom 345 or a door phone 345. The living room 4 also has a gas valve 346 enabling a user to shut off the gas valve when going on vacation, for example. The living room 4 additionally has the master set-top-box (STB) 4 (100), a telephone (TEL) 4 (350), and a window 4 (347).

The FIG. 1 shows the wireless local area network (WLAN) 360. As shown in FIG. 1, the wireless local area network (WLAN) 360 allows the remote control unit 200 to communicate wirelessly with personal computer 1, personal computer 2, personal computer 3, and master set-top-box 100. As shown in FIG. 1, the infrared communication 362 allows the remote control unit 200 to perform direct infrared communication with the devices and appliances which have the capability to perform such communication.

The set-top-box 100 can be referred to as a main control unit 100. The main control unit 100 and the remote control unit 200 can be referred to as elements of a home network system, or elements of a network system, or elements of a system. The FIG. 1 shows a home network system including main control unit 100, remote control unit 200, and a plurality of devices and appliances.

The master set-top-box 100 can be capable of wireless communication. The set-top-box 100 is connected to at least one of devices and appliances wirelessly or through wires, in order to create the home network. The set-top-box 100 performs communications, receives appliance control signals from the integrated remote control unit 200 through a wireless local area network (WLAN), and controls the corresponding appliance.

The integrated remote control unit 200 is connected to the set-top-box 100 through a wireless local area network (WLAN) and performs communication. More particularly, the integrated remote control unit 200 sends control signals for controlling home networked appliances through wires or wirelessly to the set-top-box 100 via the wireless local area network (WLAN). In this manner, the integrated remote control unit 200 is capable of controlling all appliances from a remote location by transmitting appliance control commands to the corresponding appliances irrespective of the physical location of the appliances.

The set-top-box 100 and the integrated remote control unit 200 do communicate with each other through wireless local area network (WLAN). For example, when the integrated remote control unit 200 selects a particular appliance to control while having communication with the set-top-box 100, and gives a control command to the set-top-box 100, the set-top-box 100 then controls the appliance in response to the command.

Provided that communication between the integrated remote control unit 200 and set-top-box 100 continues, users can control appliances in any room using the integrated remote control unit 200 without being restricted by control positions. That is, a user can use controller 200 to control any device connected to the home network system as long, as the user is in the range of the wireless local area network (WLAN). For example, a user can use controller 200 to turn off light 1 in room 1, even when the user and the controller 200 are physically located in room 3.

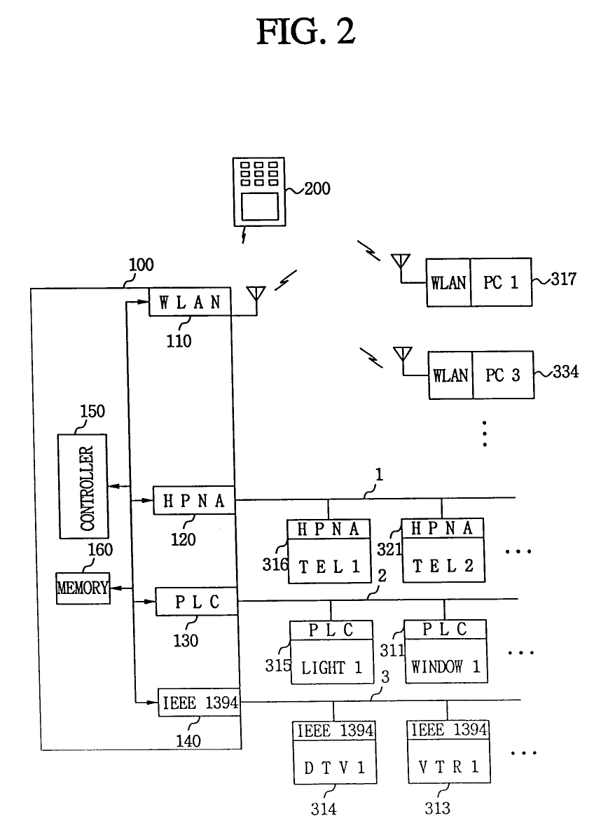

FIG. 2 is a schematic unit diagram of the home network system of FIG. 1, in which components of the system are arrayed in interfaces, in accordance with the principles of the present invention. As depicted in FIG. 2, the set-top-box 100 includes a wireless local area network (WLAN) interface 110 and a Home Phoneline Networking Alliance (HPNA) interface 120. Home Phoneline Networking Alliance (HPNA) is a home networking standard that allows components of a home network to interact over the home's existing telephone wiring without disturbing the existing telephone services. The HPNA interface 120 shown in FIG. 2 can represent any network utilizing a home's telephone wiring and is not restricted only to the HPNA networking standard. The wireless local area network interface 110 can also be referred to as a wireless interface 110.

As shown in FIG. 2, the set-top-box 100 also includes a power line communication (PLC) controller 130. Power line communication (PLC) is a home networking method that allows components of a home network to interact over the home's existing electrical power supply cables without disturbing the existing electrical power supplied in the home.

As shown in FIG. 2, the set-top-box 100 also includes a controller 150 for overall control, a memory 160, and an IEEE 1394 interface 140. The IEEE 1394 interface 140 is based on a standard of the Institute of Electrical and Electronics Engineers, Inc. (IEEE). The IEEE 1394 interface 140 can also be referred to as a Firewire™ interface 140 or as an Institute of Electrical and Electronics Engineers 1394 interface.

The WLAN interface 110 is connected, through the wireless connection, to devices and appliances 317, 334, and others which have a WLAN interface module, and also to the integrated remote control unit 200, for doing wireless communication. A user can use the remote control unit 200 to wirelessly send instructions to the set-top-box 100, in order to control or access any device shown in FIG. 1.

The HPNA interface 120 is connected, through a telephone line 1 of a subscriber's house, to appliances 316, 321, and other which have an HPNA interface module.

The PLC controller 130 is connected, through a power line 2 in the subscriber's house, to appliances 315, 311, and others which have a PLC controller. Here, power line communication 18 (PLC) indicates a system that converts communication signals to 100 kilohertz (KHz)-30 megahertz (MHz) radio frequency (RF) signals through the power line installed in a home or office, separates the RF signals through a RF filter, and receives the signals.

In general, 60 hertz (Hz) alternating current (AC) is used domestically. Thus household appliances convert the alternating current to direct current (DC) through an AC-to-DC converter, and because radio frequency (RF) signals in power line communication are low output signals, they do not influence the operations of appliances.

One of advantages of the above power line communication (PLC) is that no separate communication line is needed because the system is easily accessible. That is, such a system is easily accessible using a concentrator.

The disadvantages of a power line communication network are that transmission power is limited, there is high load interference, noises, signal interference and impedance. Also, frequency characteristics are something to be careful of as well.

Regarding other advantages of the PLC, a user can control household appliances from a remote site using a remote controller, mobile phone, or the Internet. For example, the PLC is appropriate for lighting control, home security like intrusion detection, disaster prevention like gas valve control, home automation like cooling/heating appliance control, remote inspection of a meter, and remote monitoring. Thus the user now can control lighting appliances (lamps) or security cameras, for example.

The IEEE 1394 interface 140 is connected, through an IEEE 1394 cable, to appliances 314,313, and others which have an IEEE 1394 module. IEEE 1394 is an IEEE standard size for a high-speed direct interface, and diverse multimedia audio/video (A/V) appliances can be connected thereto. Possible data transfer modes with this size are isochronous transfer mode and asynchronous transfer mode.

Sub set-top-boxes (STBs) in each room or audio/video (A/V) appliances are connected to wireless or wired IEEE 1394. Using IEEE 1394 makes it possible to control every kind of audio/video (A/V) appliance. Audio/video control messages are sent in the standard asynchronous transfer mode, and broadcast and audio streams are sent in the standard isochronous transfer mode.

The controller 150 controls overall communication between the household appliances being connected to the set-top-box through wires or wireless and set-top-box 100. In other words, when a household appliance is connected to the first set-top-box 100, the controller 150 detects information about the corresponding appliance and stores the information in the memory 160 and provides a separate identifier (ID) to the appliance for management.

When an appliance control signal is sent from the integrated remote control unit 200 through the WLAN interface 110, the controller 150 reads the information about the corresponding appliance and controls the appliance through an internal communication interface connected to the appliance.

The memory 160 stores operation programs of the controller 150 and all data. The data includes information about every household appliance connected to the set-top-box 100. More specifically, identifiers (IDs) of appliances, product numbers, serial numbers, infrared (IR) protocol information, etc., correspond to the data.

In at least one of the drawings, the WLAN interface 110 is denoted as “WLAN”, the HPNA interface 120 as “HPNA”, the PLC controller 140 as “PLC”, and the IEEE 1394 interface 140 as “IEEE 1394”.

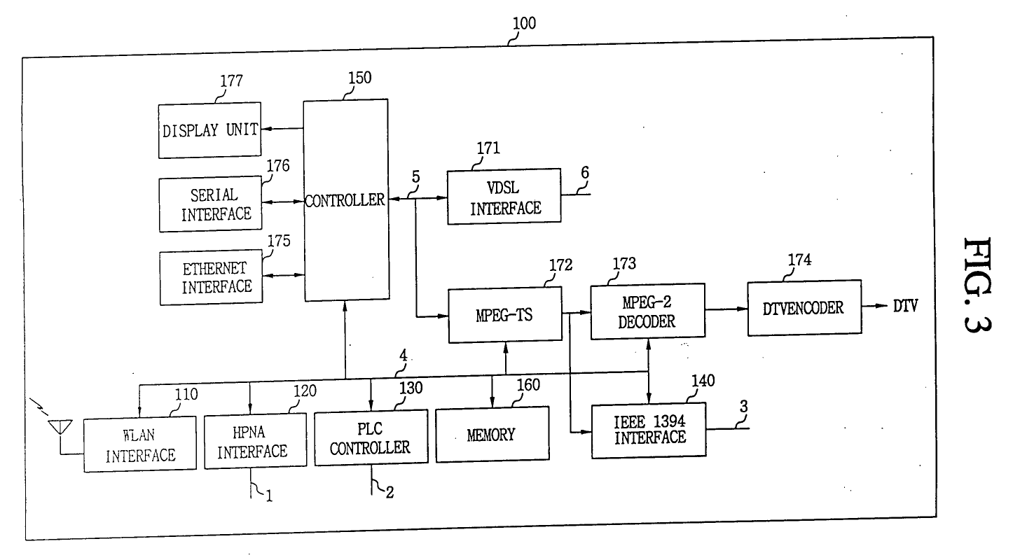

Besides the above configurations, other functional modules can be added to the set-top-box 100 of FIG. 2 for operating the home network system illustrated in FIG. 1. The FIG. 3 is a diagram illustrating a detailed configuration of a set-top-box shown in FIG. 2, in accordance with the principles of the present invention. As shown in FIG. 3, the set-top-box 100 can further include a VDSL interface 171 connected to lines 5 and 6. The VDSL interface 171 is used for demodulating very high-data rate digital subscriber line (VDSL) frames being received through a VDSL and converting the demodulated VDSL frames to asynchronous transfer mode (ATM) cells, and modulating ATM cells to be transmitted through VDSL to VDSL frames and transmitting the modulated frames through the VDSL.

The Moving Picture Experts Group is also known as MPEG. The FIG. 3 shows an MPEG-TS unit 172 for converting MPEG transfer stream (TS) associated ATM cells being received through the VDSL interface 171 to MPEG TS.

The FIG. 3 shows an MPEG-2 decoder 173 for decoding audio data and video data provided from the MPEG-TS unit 172. The FIG. 3 also depicts a digital television (DTV) encoder 174 connected to a digital television for encoding the decoded audio data and video data by the MPEG-2 decoder and transmitting the encoded data to the DTV. The FIG. 3 additionally shows an Ethernet interface 175 connected to a personal computer (PC) and the Internet, a serial interface 176, and a display unit 177. In FIG. 3, the IEEE 1394 interface 140 is connected to line 3, the HPNA interface 120 is connected to line 1, and the PLC controller 130 is connected to line 2. In FIG. 3, the line 4 connects the controller 150 to the units 110, 120, 130, 140, 160, 172, and 173.

This document does not provide a highly detailed description regarding the reproduction of audio data or video data at a variety of multimedia appliances in a home through the set-top-box 100, and does not provide a highly detailed description regarding general technologies with respect to using the Internet. Instead, this document will focus on a discussion of how to control household appliances using a remote control unit 200 through the set-top-box 100, in accordance with the principles of the present invention.

The term “internal communication interface” will be used in the specification. This term is used because the above-discussed HPNA interface 120, PLC controller 130, and IEEE 1394 interface 140 are all communication interface modules, each being connected to household appliances through wires or wirelessly to perform communication. An “internal communication interface” can also be referred to as a “communication interface”.

Also, the wireless LAN, which is used as another communication interface module between the set-top-box and household appliances, can also be called an internal communication interface in a narrow sense. Additionally, the WLAN interface 110 illustrated in FIG. 2 is separately classified as a WLAN interface module because it performs not only wireless communication between appliances but also wireless communication between the set-top-box 100 and remote control unit 200. Therefore, the ‘internal communication interface’ is one interface selected from among WLAN network, IEEE 1394, HPNA and PLC.

The FIG. 1 shows a plurality of set-top-boxes including a master set-top-box 100, a sub set-top-box 1 (312), and another sub set-top-box 2 (322). The term “set-top-box 100” throughout the description is the master set-top-box 100 in living room 4. The set-top-boxes in rooms 1, 2, and 3 will be denoted as ‘sub set-top-boxes’. The sub set-top-boxes 312 and 322 enable a viewer to watch a digital broadcast on their respective digital televisions (314 and 323) and to use contents of interest on the digital televisions. That is, sub set-top-boxes 312 and 322 permit a viewer to maintain local control over the digital televisions 314 and 323, respectively. The functions of the sub set-top-boxes 312 and 322 can also be performed by the master set-top-box 100, because the control signal of an integrated remote controller is transmitted through the master set-top-box 100 to each appliance, so that each appliance can be controlled from the master set-top-box 100.

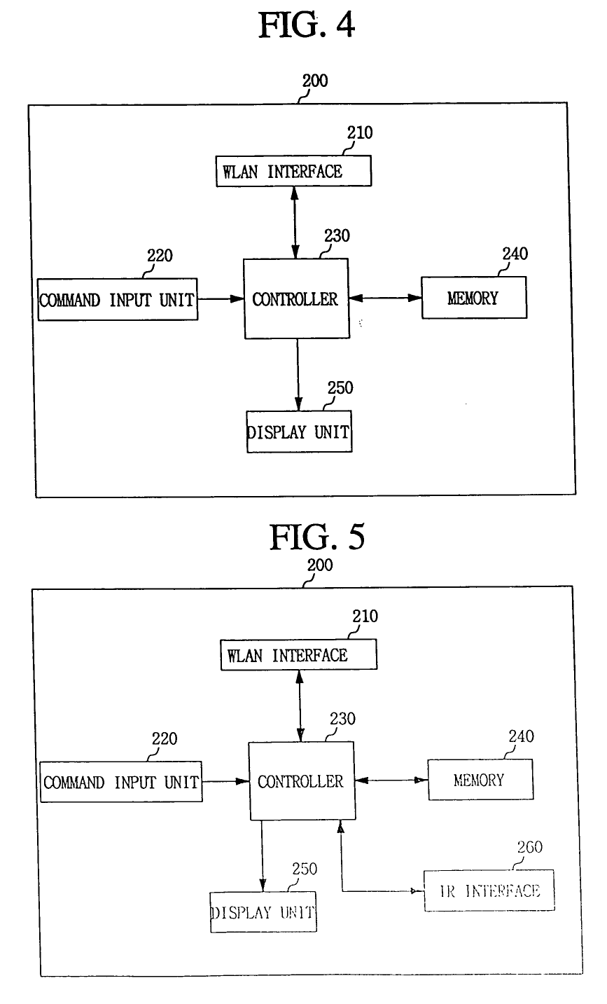

FIG. 4 is a unit diagram of an embodiment of a remote controller, in accordance with the principles of the present invention. With reference to FIG. 4, the remote control unit 200 includes a WLAN interface 210 in wireless communication with the set-top-box 100. The set-top-box 100 is connected to at least one appliance, to form a home network, through wires or wirelessly for performing communication through WLAN.

FIG. 4 shows a command input unit 220 for inputting a control command on any appliance in a home. The FIG. 4 also shows a controller 230 for generating a control signal in response to an input command through the command input unit 220, enabling the appliance to control the corresponding appliance that is connected to the set-top-box 100 either through wires or wirelessly, and for transmitting the control signal to the set-top-box 100 through the WLAN interface 210. The FIG. 4 additionally shows a memory 240 for storing various information needed to control every appliance, and a display unit 250 for displaying screen information-for appliance control.

In FIG. 4, the controller 230 provides the screen information for appliance control to the display unit 250 using graphical user interface (GUI), and displays how the command provided from the command input unit 220 is being executed. The controller 230 provides the screen information for appliance control to the display unit 250 in a form of a graphical user interface (OUI). Thus the display unit 250 displays a status of commands, such as “command initiated”, “command pending”, “command not able to be completed at this time”, and “command completed” or “command executed”.

The WLAN interface 210 is used to allow the integrated remote control unit 200 to perform wireless communication with the set-top-box 100. The WLAN interface 210 of the remote control unit 200 communicates with the WLAN interface 110 of the set-top-box 100.

As shown in FIG. 4, the command input unit 220 is a module for inputting control commands on any arbitrary appliance among the household appliances. A keypad with alphanumeric keys, or special function keys, can be used for inputting commands. Commands for appliance control can be input using a touch-sensitive screen, such as a liquid crystal touch screen for example.

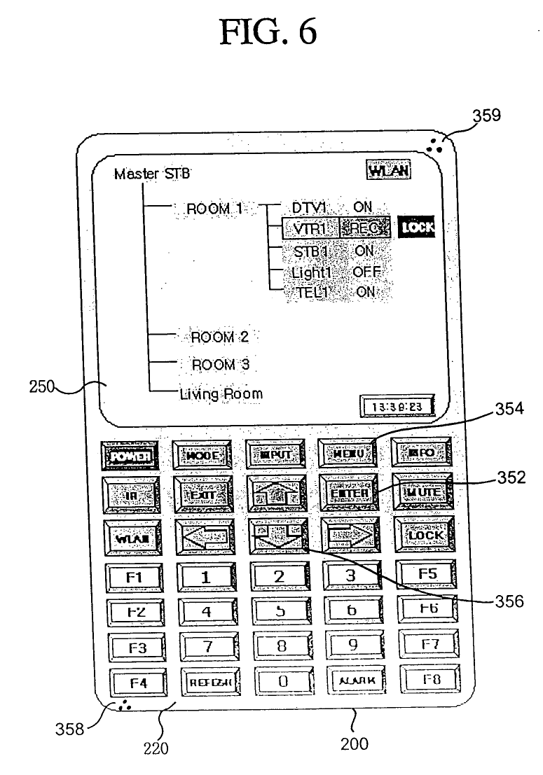

Audible voice commands or other audible commands can be input in order to input commands. On the remote control unit 200, the microphone 358 shown in FIG. 6 can be used to input voice commands. For example, a user can speak into the microphone 358 to give a command to the set-top-box 100. Thus, the user can clearly state “DTV1 on” into the microphone 358. This voice command can be saved in a file, the file can be transmitted through the WLAN to the set-top-box 100, the set-top-box 100 can detect the contents of that file, and then the corresponding command can be implemented by the set-top-box 100, so that the digital television 1 in room 1 is turned on. Other devices and methods can be used to enter commands.

A first alternative device can be worn by a user and can be used to enter commands. This first alternative device can be called a wearable computer or portable device. In this case, the portable device includes a very small display unit, an eye-movement detector, a controller, and a wireless transceiver. The wireless transceiver can communicate with the WLAN interface 110 shown in FIG. 2. The very small display unit is positioned to be near one of the user's eyes. The display unit can display a short list of commands, such as “main menu” and “turn on DTV1” and “Change channel of DTV1”, for example. When the portable device is properly configured and calibrated, the user can select a command merely by looking at that command listed on the very small display unit. When the user selects “main menu” by looking or staring at that command, a menu including other commands is displayed on the very small display unit. Portable devices including eye-movement detection devices, such as the one described above, do exist today. Similar devices have been fitted to the helmets of military pilots, so that the pilots can perform additional functions without taking the hands away from flight controls. Similar devices can be used by home-owners, too, as described above. Such portable devices can be expensive, but costs and retail prices are expected to continue to decrease in the future. Using this type of portable device, the user can control all the appliances shown in FIG. 1 without moving any fingers, without pressing a button, without touching a touch-sensitive screen, and without speaking any commands.

A second alternative device that can be used for inputting commands is as follows. In the second alternative device, the controller 200 can project a large image on a wall or any other surface, and that image can include a plurality of commands and icons available to be selected by the user. FIG. 6 diagrammatically illustrates a screen being displayed on a display unit of the remote controller, in accordance with the principles of the present invention. The command input unit 220 can be a keypad 220, as shown in FIG. 6. The user would scroll through and then select a command, or icon, by pressing directional arrow keys and then the “Enter” key 352 on a keypad 220 of the controller 200. As the user presses the down directional arrow key 356 on the keypad 220 on the controller 200, for example, the image projected on the wall would depict each of the different commands being highlighted in turn, to correspond with the user's pressing of the down directional arrow key 356. When the desired command is highlighted, the user can press the “Enter” key 352 to select the desired command. By projecting the image onto a wall, ceiling, or other surface, in this way, a very large image can be displayed for the user, larger than the image displayed on the display unit 250.

Also, a combination of the above devices and methods can be used to input commands. In case of the keypad, users can press any particular key button on the remote controller, or combine several key buttons to implement various control functions. Due to the development of liquid crystal technologies, adapting liquid crystal to a touch screen, users are provided with information on a screen with icons representing different appliance shapes, and all the users need to do is to touch a corresponding icon and control an appliance represented thereby.

For example, the touch screen might display a simple picture or icon of a lamp. When the user touches that icon with a stylus or with a finger, then a menu appears listing the following options: “light 1”; “light 2”; and “light 3”. When the user touches “light 2”, then another menu appears listing the following options: “turn on”; “turn off”; “increase brightness”; “decrease brightness”; and “cancel”. When the user selects “turn off” on the remote control unit 200, then a corresponding command is sent wirelessly from the WLAN interface 210 to the WLAN interface 110 in set-top-box 100. Then the command is sent to PLC 130 and next to the light 2 in room 2. Then the light 2 is turned off.

When a command is inputted through the command input unit 220, the controller 230 interprets the command, generates a control signal in response to the command to control the appliance being connected to the set-top-box 100 through wires or wirelessly, and transmits the control signal to the set-top-box 100 through the WLAN interface 210.

For example, if a user touches a keypad of the command input unit 220 and selects a control command for controlling a particular appliance, the controller 230 generates a control signal corresponding to the command and transmits the control signal to the set-top-box 100 through the WLAN interface 210.

The memory 240 stores information relating to a keypad on command input unit 220, and relating to keypads of individual remote control units associated with individual appliances, such as a remote control unit included with a television that can only control that television. All this information can be stored in memory 240. This information stored in memory 240 enables the user to control appliances through the command input unit 220. In addition, the memory 240 can also store information about remote controllable appliances and information in connection with controlling appliances to be displayed on the display unit 250.

The display unit 250 can display information about different kinds of appliances and menu information for appliance control. More specifically, the display unit 250 displays information provided from the set-top-box 100 regarding all appliances that are connected to the set-top-box 100 as well as information having been stored in the memory 240.

Preferably, the information about the appliances is displayed in a manner that allows 1I users to easily recognize appliances, and then control a particular appliance. Considering that graphics are easier to recognize than text, the display unit 250 can draw a tree-shaped structure according to the arrangement of rooms with appliances, using a graphical user interface (GUI). When displaying the appliances in a form of the tree-shaped structure, the display unit 250 can use a command icon method to help users to control appliances even more conveniently.

One of the strong points of this method is that the users are provided with visual screen information on various household appliances. If the display unit 250 is not available, users can still designate a controlled appliance or choose to control the designated appliance through the command input unit 220. In such case, however, more key buttons need to be added to the keypad for use in the command input unit 220. Thus as more appliances are involved, the display unit 250 plays an essential role.

There will probably be times when the menu information will be updated, as more household appliances are added to the home network system. Therefore, for users' convenience, the integrated remote controller preferably includes the display unit 250 for providing users with timely visual information and menu for controlling each appliance.

The following describes a method for controlling household appliances using the integrated remote control unit 200 and master set-top-box 100 of the invention. Every household 8 appliance is connected to and managed by the set-top-box 100, which is the center of the home network system. Also, every household appliance is interconnected to each other through IEEE 1394, HPNA, PLC, WLAN, and other networks. The set-top-box 100 gives slave identifiers (IDs) to all appliances except for itself, according to the positions and types of the appliances, and registers new appliances so that those new appliances can be controlled.

More specifically, when an appliance is added to or deleted from the home network system, the set-top-box 100 automatically detects such incidence and turns to a registration/deletion standby mode, so using the set-top-box 100 users can personally register new appliances, delete old appliances, and manage all the appliances.

The integrated remote control unit 200 receives the information about all appliances from the set-top-box 100 through the WLAN interface 210, and stores the information in the memory 240. The controller 230 reads out the stored information on the appliances and displays the information on the display unit 250. Distinguishing positions of the appliances, for example room 1, room 2, room 3, and room 4, in the home, the display unit 250 helps users to know the positions of the appliances almost instinctively. There are four sub-directories, one for each room. In the sub-directory corresponding to room 1, for example, there are icons with the names of all the appliances in room 1.

If the user selects a particular appliance being displayed on the display unit 250 by pressing a button on the command input unit 220, the controller 230 interprets an input command through the command input unit 220 and displays on the display unit 250 that the appliance has been selected. Also the controller 230 transmits a wireless control signal for the appliance to the set-top-box 100 through the WLAN interface 210.

At this time, the control signal from the integrated remote control unit 200 is sent to the WLAN interface 110 of the set-top-box 100 through the WLAN interface 210, so wherever the integrated remote controller is, for example room 1, room 2, room 3, or room 4, the integrated remote control unit 200 and the set-top-box 100 can transmit and receive control signals for any appliance.

For example, when the integrated remote control unit 200 is in the room 4 as shown in FIG. 1, and the user wants to control the “light 1” (315) in the room 1, the following steps will occur. Upon receiving a control signal for that particular appliance from the integrated remote control unit 200 through the WLAN interface 100, the controller 150 of the set-top-box 100 interprets the control signal and controls the corresponding appliance through the internal communication interface module to which the light appliance belongs. For instance, the control signal in this case is intended to turn on the light 1 (315) in the room 1. Then this can be accomplished through the PLC controller 130.

The controller 230 of the integrated remote control unit 200 unilaterally transmits the control signal to the set-top-box 100, in response to the input command through the command input unit 220, and the controller 150 of the set-top-box 100 performs one-way control on the corresponding appliance.

After the controller 230 of the integrated remote control unit 200 unilaterally transmits the wireless control signal to the set-top-box 100, in response to the input command through the command input unit 220, and the controller 150 of the set-top-box 100 performs one-way control on the corresponding appliance, the present control result of the appliance is received and a control result signal of the appliance is again transmitted to the integrated remote control unit 200. In this way, the integrated remote control unit 200 can easily find out whether the command it gave has been properly executed.

Thus, WLAN communication is appropriate for controlling an appliance located at a remote place from the user. If the user wants to control the appliance using the integrated remote control unit 200, the integrated remote control unit 200 selects the appliance and generates an appliance control signal. This appliance control signal is transmitted to the set-top-box 100 through WLAN, and the set-top-box 100 then transmits the control signal to the corresponding appliance through IEEE 1394, HPNA, PLC, or WLAN, whichever network the appliance is connected to.

Receiving the control signal, the appliance performs an appropriate operation as commanded and sends its operation result back to the set-top-box 100. Then the set-top-box 100 transmits the control result signal through the WLAN to the remote control unit 200 held by the user. The remote control unit 200 receives the control result signal from the set-top-box 100, displays it to the user, and converts to a standby mode. If the information from the set-top-box 100 is different from the control signal generated by the user, an alarm is issued and an operation mode is maintained.

FIG. 5 is a unit diagram of an embodiment of a remote controller, in accordance with the principles of the present invention. With reference to FIG. 5, the remote control unit 200 includes a WLAN interface 210 in communication with a set-top-box 100 being connected to at least one of appliances to compose the home network through wires or wirelessly for performing communication through WLAN; a command input unit 220 for inputting a control command on any appliance in a home; a controller 230 for generating a control signal in response to an input command through the command input unit 220, enabling the appliance to control the corresponding appliance that is connected to the set-top-box 100 either through wires or wirelessly, and for transmitting the control signal to the set-top-box 100 through the WLAN interface 210; a memory 240 for storing operational programs of the controller 230 and for storing data; a display unit 250 for displaying screen information for appliance control; and an infrared (IR) interface 260 for performing IR communication with an appliance at a short distance within a limited space.

The IR interface 260 can be used to control an appliance that is in the proximity of the remote control unit 200. The IR interface 260 can be used to control an appliance that is within a predetermined distance of the remote control unit 200. When the IR interface 260 is used, the controller 230 sends an infrared appliance control signal or an infrared device control signal through the IR interface 260 to the appliance or device that is in the proximity of the remote control unit 200. For example, in the arrangement shown in FIG. 1, the remote control unit 200 can use the infrared interface 260 to communicate directly with the DTV1 (342) by infrared communication with the infrared transceiver 364 mounted on the DTV1 (342). The infrared transceiver 364 is able to receive infrared signals from the remote control unit 200 and is able to send infrared signals to the remote control unit 200.

The controller 230, through the infrared (IR) interface 260, sends an appliance control signal or infrared control signal corresponding to an input command provided through the command input unit 220, to control the appliance at a short distance. Since most of the operations of the integrated remote control unit 200 with the above configuration are already provided with reference to FIG. 4, the following will discuss only parts that are not explained in FIG. 4.

Thus, as mentioned before, the user can control a particular appliance in the home by using the integrated remote control unit 200, and more particularly, by performing WLAN communication with the set-top-box 100. One of advantages of this case is that the user can control appliances in other rooms while enjoying mobility.

As described above, with reference to FIG. 4, when a user wants to control appliances that are located in different rooms, that user must use the display unit 250 to locate a name or icon corresponding to the appliance, and also that user must select the appliance's name or icon.

However, in accordance with the embodiment depicted in FIG. 5, if the appliance that the user wanted to control using the integrated remote control unit 200 happens to be in the same room with the user, and thus, infrared (IR) communication is possible, that user does not have to find the appliance in the display unit 250 and select the appliance. That user can merely use infrared communication to control that appliance that is in the same room as the user.

More specifically, the command input unit 220 has a key button through which the user can select either infrared (IR) mode using IR interface 260, or wireless local area network (WLAN) mode using WLAN interface 210. When the user selects the IR mode, the integrated remote control unit 200 converts to the IR mode from its normal mode, namely the WLAN mode.

Once the integrated remote control unit 200 enters to the IR mode, the controller 230 interprets a command being input through the command input unit 220 and sends a corresponding control signal to a corresponding appliance through the IR interface 260. The corresponding appliance has an IR receive module, so it can carry out an operation in response to the appliance control signal provided by the integrated remote control unit 200.

One thing to be careful of here is the fact that, because there are many appliances in a room, it is preferred that the infrared (IR) signal from the integrated remote control unit 200 does not interfere or influence other appliances in the room. This is why information about the IR communication module of each separate appliance should be prestored in the memory 240 of the integrated remote control unit 200. The memory 240 can store specification on the IR communication module of each appliance in a home from the beginning, so when there is a request for the set-top-box 100 to provide information about the IR communication module of a corresponding appliance after the user selects the IR mode and a particular appliance to be controlled using the command input unit 220. In this case, the set-top-box 100 transmits the prestored specification regarding the IR module of an appliance to the integrated remote control unit 200, if the integrated remote control unit 200 requests the specification. The set-top-box 100 of the present invention can be configured to automatically acquire the specifications regarding the infrared modules of each appliance as soon as that appliance is connected to the networks shown in FIG. 1 or other networks.

To summarize, the controller 230 of the integrated remote control unit 200 sends a control signal to a corresponding appliance through the IR interface 260, in response to an input command through the command input unit 220. Then the corresponding appliance receives the control signal and performs an operation as commanded. The embodiment being described here involves infrared communication that is a one-way control. Note that two-way control is possible, and two-way control will be described later. However, for the time being, one-way control is is being described. With one-way control, the controller 220 transmits the infrared signal to the appliance, and the appliance does not transmit an infrared signal back to the controller 220.

Even with one-way infrared control, the changed status of the appliance can be transmitted through the HPNA network, PLC network, IEEE 1394 network, and wireless local area network, however, so that the current status of all appliances is always available to the set-top-box 100. The set-top-box 100 can then transmit the current status of all appliances to the remote controller 220 through the WLAN.

The controller 230 of the integrated remote control unit 200 sends a control signal to a corresponding appliance through the IR interface 260, in response to an input command through the command input unit 220. The corresponding appliance having received the control signal performs an operation as commanded.

Now two-way infrared control will be described. After the infrared interface 260 transmits a command to the appliance by infrared (IR) communication, the controller 230 of the integrated remote control unit 200 may transmit the present control result to the appliance again and find out whether the command it gave has been properly executed, that is, two-way control. To implement the two-way control, the appliance should have an IR receive module and also an IR transmission module. Thus, the IR interface 260 of the integrated remote control unit 200 should have a transmission module as well as receive module.

Provided that the two-way control using WLAN communication between the integrated remote control unit 200 and the set-top-box 100 is possible, there are two methods for the integrated remote control unit 200 to control household appliances when performing the two-way control using IR communication between the integrated remote control unit 200 and a corresponding appliance.

As discussed before, the remote controller has the IR interface and WLAN interface for communication with appliances. According to the transmitting/receiving method using IR, if an appliance being controllable by an IR appliance control signal is placed at a short distance from the user, IR can be used to directly control an appliance and to directly receive results of the control commands.

On the other hand, according to the transmitting/receiving method using WLAN, WLAN is usually used for controlling other appliances that do not operate under the IR appliance control signal and receiving control results thereof, or for controlling other household appliances that are controllable by the IR appliance control signals but located at remote places and receiving control results thereof.

The following describes controlling appliances using IR communication. This procedure can be applied when an appliance being operated under an appliance control signal using IR is located at a short-distance from the user. In general, when appliances are registered to the set-top-box 100 the first time, information about kinds of IR communication protocols of appliances and their systems are transmitted together to the integrated remote controller. Thus a user can use IR communication immediately after selecting an appliance, say, right in front of the user.

As the user controls the appliance using the integrated remote control unit 200, the appliance receives an IR communication control signal and starts its operation. Also the appliance under command transmits a result signal indicating the operation is in normal progress to the remote controller via IR communication, and at the same time reports its operation status to the set-top-box through its internal communication interface IEEE 1394, HPNA, PLC or WLAN, for example.

The integrated remote control unit 200 queues an IR result signal from the appliance for less than 10 seconds after the user generated the appliance control signal, and if the IR result signal is duly received from the appliance within 10 seconds, the integrated remote control unit 200 displays its acceptance to the user. But if not, the integrated remote control unit 200 accesses to the set-top-box 100 using WLAN, receives the operation status of the corresponding appliance, and displays it to the user and is converted to a standby mode. If the information from the set-top-box 100 is different from the control signal generated by the user, an alarm is issued and the operation mode is kept or maintained, in lieu of the standby mode.

In case of appliances being not controllable with IR appliance control signals, or with any form of direct control, the user can still control those appliances through communication between the integrated remote control unit 200 and set-top-box 100 via the WLAN.

When the integrated remote control unit 200 sends out an appliance control signal through IR communication, a corresponding appliance having received the appliance control signal transmits a result signal indicating that the appliance has a normal status conforming to the control signal to the integrated remote control unit 200 using IR and at the same time transmits its operation status to the set-top-box 100 through its internal communication interface IEEE 1394, HPNA, PLC or WLAN. The set-top-box 100 then transmits the control result signal provided by the corresponding appliance to the integrated remote control unit 200 through WLAN.

However in some cases an appliance having received an appliance control signal from the integrated remote control unit 200 may not transmit its control result signal through a transmission IR module and may not report its operation status to the set-top-box 100 through the internal communication interface IEEE 1394, HPNA, PLC or WLAN. In such case, the integrated remote control unit 200 queues an IR result signal from the appliance for less than 10 seconds after the user sends an appliance control signal to an arbitrary appliance, and if the IR result signal is duly received from the appliance within 10 seconds, the integrated remote control unit 200 displays its acceptance to the user. But if not, the integrated remote control unit 200 accesses the set-top-box 100 using WLAN, and requests the control result information of the appliance.

As such, the set-top-box 100 requests the corresponding appliance to provide the present l control result thereof, and transmits the received control result information to the integrated remote control unit 200. Upon receiving the control result information, the integrated remote control unit 200 displays the information to the user and is converted to the standby mode. If the information from the set-top-box is different from the control signal generated by the user, an alarm is issued and the operation mode is maintained.

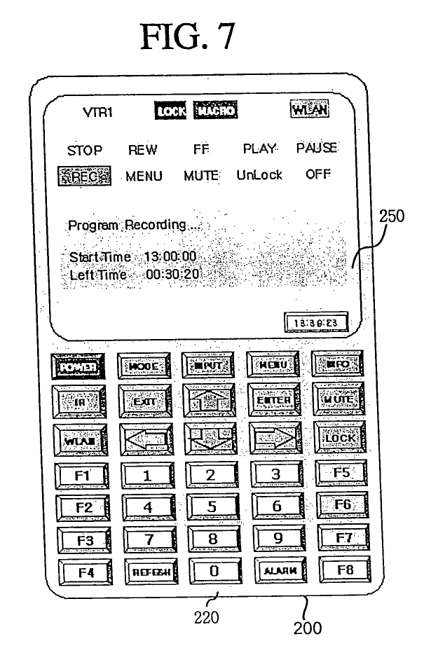

FIG. 6 diagrammatically illustrates a screen being displayed on a display unit of the remote controller, in accordance with the principles of the present invention. FIG. 7 illustrates a screen being displayed on a display unit of the remote controller, in accordance with the principles of the present invention. FIGS. 6 and 7 illustrate the remote controller of the present invention.

Referring to FIGS. 6 and 7, the integrated remote control unit 200 includes a display unit 250 on a front surface, and a command input unit 220 with a plurality of key buttons.

The plurality of key buttons are composed of a power button for turning power on and off; a mode button through which the user selects either standby power mode or operation power mode; an input button through which the user selects an input; a menu button 354 for displaying an appliance control menu; an infrared (IR) button for setting up IR mode; an exit button for exiting the present operation at the display unit; an enter button 352; a mute button; a wireless local area network (WLAN) button for setting WLAN operations; a lock button for locking or unlocking; a shift button for shifting horizontally and vertically; a number button; and a function key buttons from F1 through F8 for macro functions. Further, a refresh button for resetting the set-top-box and an alarm button for setting an alarm can be included. The shift buttons can also be described as directional arrow buttons or directional arrow keys, including the down directional arrow key 356.

As shown in FIGS. 6 and 7, the user interface of the integrated remote controller takes a tree-shaped appliance arrangement or uses command icons.

The tree-shaped arrangement is made on the basis of rooms where corresponding appliances are positioned. Constructing screen information by arranging appliances according to the rooms, the user can easily locate an appliance that the user desires to control.

In other words, the display unit 250 of the integrated remote control unit 200 as shown in FIG. 6 has directories named room 1, room 2, room 3, and living room, under the master set-top-box box (STB) directory, and the room 1 directory has sub-directories, for example DTV 1, VTR 1, STB 1, Light 1, and TEL 1. Thus it is easy for any user to conveniently find an appliance to control.

A command icon function is available on the remote control unit 200. As shown in FIGS. 6 and 7, the command icon function operates as follows. As depicted in FIG. 6, first a user selects a category such as “ROOM 1”, and then the user selects an appliance to control, such as “VTR1”. At this time, execution icons corresponding to executable commands available in the selected appliance are displayed, as shown in FIG. 7. Then everything the user needs to do select the wanted operations can be executed in response to a movement of the directional arrow keys.

For example, if the user selects VTR 1 of FIG. 1 on the integrated remote control unit 200, the display unit displays screen information that looks like FIG. 7. That is, the user is provided with a number of command icons for controlling every available operation of the VTR 1.

In FIG. 7, the user will select the “STOP” icon or “STOP” text in order to stop operation of the VTR 1. The “REW” denotes that the user wants to rewind. The “FF” denotes fast forwarding, “PLAY” denotes reproduction, “REC” denotes recording, “MENU” corresponds to a viewing menu, “MUTE” denotes muting the sound, “Unlock” denotes removing the lock or unlocking the lock, and “OFF” denotes turning off the power.

Also, a macro command function can be performed using function keys F1 through F8 shown in FIGS. 6 and 7. The macro function predesignates the user's favorite commands and allows a user to select a category, an appliance, and even select the command for that appliance, by pressing a single button. That is, the macro function is a shortcut key for executing a specific command or a series of several commands on one or more appliances, in response to a particular key input of the command input unit.

For instance, if the user executes a locking-doors macro command, the present status of the front door, window 1, window 2, window 3, window 4, gas valve, and lights are checked in sequence and displayed, then the front door is locked, the windows are locked, the gas valve is turned off, and the lights are turned off. Also, in order to help protect the home from intruders, the locking-doors macro command can be used to set a security alarm system when the alarm system is connected to the WLAN shown in FIG. 1.

Further, the user can execute command reservation and timer functions. The command reservation and timer functions make sure appliances are operated on a designated time for a designated time period only, as the user requested. To accomplish this, a timer can be installed in the integrated remote control unit 200. Thus, the integrated remote control unit 200, using the timer, checks the time and transmits a reserved command to the set-top-box 100 at a pre-designated time to execute the command properly.

In addition, as more than one family member usually lives in a home, the locking and unlocking function becomes convenient for the family members assuming that there are many remote control units 200 for them in that home.

The locking and unlocking function involves selecting an appliance in response to a specific key input, designating an exclusive command for an exclusive control on the appliance, canceling the designated command, and transmitting the corresponding command to the set-top-box 100. If the exclusive control command on the appliance is set up for a certain period of time, this information is displayed on the screen, telling the user that the corresponding appliance cannot be controlled at the moment.

Each of the plurality of remote control units 200 has its own identifier (ID), and the set-top-box 100 stores the identifier (ID) information. In case several users try to use one appliance at the same time by using the locking function, the first user has a priority to perform the locking function on the appliance to prevent duplicated commands on the same appliance. If a user presses the “LOCK” button on the integrated remote control unit 200 and locks a certain appliance, this locking command is registered in the set-top-box 100 and only that user can unlock the appliance later.

Once the appliance is locked, other users lose their control rights on the appliance using IR communication or WLAN. The locking condition is not cancelled until the user who set the condition the first time unlocks the appliance, but when the appliance is unlocked, its information in the integrated remote control unit 200 is immediately updated and other users can use the appliance. In accordance with the principles of the present invention, there can be a plurality of remote control units 200, with several of those remote control units 200 being designated as slave remote control units 200, and one or more of those controllers 200 being designated as a master remote control unit 200.

The master remote control unit 200 would be useful when a child, using a slave remote control unit 200, locks an appliance and then temporarily misplaces the slave remote control unit 200 that was used to lock that appliance. Under these conditions, the master remote control unit 200 can be used to override that lock and can thus unlock the appliance. The master remote control unit 200 might be placed in a secure place for the convenience of the parents, for example. Or the master remote control unit 200 can have a password so that it can only be used by someone who knows the password. Also, appliances can be unlocked by entering a password directly into a keypad on the set-top-box 100 itself, without any need for any remote control unit 200, in the event that the master remote control unit 200 and the slave remote control unit 200 are each temporarily misplaced while some appliances are locked.

Inline with a user's request, the locking function can be included in the macro command function and executed right away. For instance, if the locking function is included in the locking-doors macro command, the front door, windows, and gas valve are not only checked but also locked until the next morning so that no one can have control of them until then. As another example, if the locking function is included in the macro command after VTR recording started, this means that no one can use the VTR until the recording is completed.

The standby power mode and operation power mode for saving power of the remote controller shall now be described. Users can access a variety of services available in the home network system using the display unit 250 and diverse key buttons mounted on the remote control unit 200.

Users can monitor each appliance on a regular basis. Although the integrated remote control unit 200 checks the status of an appliance when the user provides a control signal therefor, if requested, it can also monitor the status of the appliance regularly or irregularly.

Every household appliance is internetworked through IEEE 1394, HPNA, PLC or WLAN, and managed by the center of the network system, that is, the set-top-box 100. Therefore, the integrated remote control unit 200 can have the information on the status of each appliance by connecting to the set-top-box 100 at regular intervals as designated by the user through WLAN, and can display the information or give an alarm, thereby improving functionality and reliability of the home network system.

When the locking-door function has been set up, then the integrated remote control unit 200 can be configured to connect to the set-top-box 100 every one minute to get the information on the locking status of corresponding appliances and issues an alarm if there is any problem. If video tape recording is in progress in another room, the user can easily monitor the status and result of the video tape recording control using the remote control without actually going to that room to monitor it.

Apart from the user's request, the integrated remote control unit 200 checks the status of the set-top-box 100 on a regular basis, and then gives an alarm if the set-top-box 100 malfunctions due to an external or internal factor, or can reset the set-top-box 100.

The integrated remote control unit 200, compared with the one-way remote controller described above, usually consumes more power because it transmits control signals to appliances and waits for control result signals from controlled appliances. To obviate this issue with the two-way remote controller of the present invention, the standby power mode and operation power mode are used. Thus, the remote controller is converted to the standby power mode from the operation power mode at any time, as long as predetermined conversion conditions are satisfied. The present invention can convert to the standby mode when any of the following predetermined conversion conditions exist: when a predetermined quantity of time has elapsed after receiving a control result signal indicating that the status of a controlled appliance is normal; when the reservation function has been set up; when the locking-door function has been set up; or when the regular monitoring function has been set up.

The remote control unit 200 is in the operation power mode when the user personally controls appliances or when an alarm is issued due to a system problem. Meanwhile, the remote control unit 200 immediately enters the standby power mode when a predetermined time has lapsed after receiving a control result signal indicating that the status of a controlled appliance is normal, or when the reservation function or looking-door function is initiated.

The regular monitoring function for monitoring the status of the home network system is done in the standby power mode. Therefore, the user does not have to connect to every appliance to find out its status but connects to the set-top-box 100 only at predetermined times. The set-top-box 100 provides the remote controller with only the information about an appliance with changed status, thereby minimizing connection time and power consumption of the remote control unit 200.

In conclusion, the present invention has the following numerous advantages, in addition to the other advantages discussed above and not explicitly listed below, and in addition to further advantages that will readily appear to those skilled in the art.

In the present invention, because one remote control unit 200 can be used to control all household appliances, irrespective of where the users are physically located, user mobility and convenience are significantly improved. A user can be physically located anywhere within the range of the wireless local area network (WLAN), and that user can control every appliance and device connected to the set-top-box 100.

In the present invention, the reliability of a home network system can be improved because the user is able to check the status of each controlled appliance on a real-time basis. Thus, the user will be more confident in the accuracy and dependability of the home network system of the present invention.

In the present invention, with the two-way communication of the remote control unit 200, power consumption of the remote controller can be reduced and efficiency maximized because of the above-described automatic conversion from the operational power mode to the standby power mode, and vice versa.

In the present invention, through regular monitoring, it is possible to check the status of every appliance on a real-time basis, and, by applying fault-tolerance to a master appliance of the home network system, availability and reliability of the home network system are improved.

In the present invention, an intuitive and easy-to-use user interface is provided, and so user convenience is greatly improved.

In the present invention, the locking function prevents confusion especially when a plurality of users try to use an appliance at the same time.

In the present invention, the integration of several different kinds of remote controllers into one remote controller allows the manufacturing costs and sales prices of the system, including the remote controller, to be reduced, and the integrated remote control unit 200 can be manufactured with different options at a user's request.

The present invention is not limited to the networks shown in FIG. 1. Thus, networks other than HPNA, PLC, IEEE 1394, and WLAN can be successfully utilized with the home appliances, the remote control unit 200 and the set-top-box 100 of the present invention. The present invention is not limited to a home. The plurality of devices and appliances shown to be interconnected in FIG. 1 can be located in a home or they can be located in a business.

The set-top-box 100 can be referred to as a main control unit 100. The remote controller 200 can be referred to as a remote control unit 200.

The devices shown in FIG. 1 can be connected wirelessly or through wires. In the description of the present invention, the terms “wire” and “wires” are not limited to only electricity-conducting wires. In the description of the present invention, the terms “wire” and “wires” can include fiber optic cable conveying light signals. Thus, in accordance with the principles of the present invention, the devices shown in FIG. 1 can be connected through wireless communication, through wire communication via electricity-conducting wires, and through fiber optic communication via light-conveying fiber optic cables.

The above-described wireless communication can include communication conforming to a Bluetooth™ standard, one or more of the standards in the IEEE 802.11 family of standards, an infrared communication standard, or any other type of wireless communication standard, for example. The present invention is not limited to any one type of communication. In the future, new types of wireless, wire, and fiber optic communication may be developed, and the present invention will be able to utilize such new types of communication. Furthermore, additional types of communication maybe developed in the future, and it is expected that the present invention will be able to utilize such additional types of communication.

Accordingly, the light 1 in room 1 can be connected to the set-top-box 100 through the power line communication (PLC) wires, as shown in FIG. 1. Or the light 1 in room 1 can be connected to the set-top-box 100 by a wireless communication method, not shown. In the wireless communication method, the light 1 can have a wireless transceiver connected to it, and then the wireless transceiver would communicate wirelessly with the set-top-box 100 in order to cause the light 1 to turn off, turn on, increase brightness, etc. Also, the light 1 can be connected to the set-top-box 100 by fiber optic cables. However, a better use of the bandwidth available with fiber optic cables would be to connect the DTV 1 to the set-top-box 100 by fiber optic cables, so that high definition digital television signals can be sent rapidly to the DTV 1 from the set-top-box 100.

Thus, the devices shown in FIG. 1 can be connected through wireless communication such as radio waves, through electricity-conducting wires, or through light-conveying fiber optic cables. For example, the light 1 is shown to be connected to set-top-box 100 by electricity-conducting wires. For example, the remote control unit 200 is shown to be connected to set-top-box 100 by wireless transmission. No devices are shown in FIG. 1 to be connected by fiber optic cables, although a use of fiber optic cables is within the scope of the present invention.

Furthermore, some of those appliances shown in FIG. 1 can be in a first home, and the other appliances shown in FIG. 1 can be in a second home. For example, the DTV 1 shown in FIG. 1 can be in room 1 in a first home, and the DTV2 can be physically moved to a second home, as long as the DTV1, DTV2, and set-top-box 100 remain networked together. An IEEE 1394 network, for example, can be utilized to connect appliances that are physically located in multiple homes and businesses, with the use of the appropriate cables and supplemental equipment, as long as the limits of the IEEE 1394 standard are not exceeded.

Additionally, the master set-top-box 100 can transmit and receive commands to and from the Internet 400, as shown in FIG. 1. For example, a user might be at work at 8:30 AM and suddenly remember that a television program starting at 10:30 AM must be recorded for a relative. The user can then access the Internet 400 while at work, and send a command through the Internet 400 to the set-top-box 100 instructing the video tape recorder (VTR) 1 to record the television program.

Also, when a telephone answering machine is connected to the network shown in FIG. 1, a user can record an outgoing message for the telephone answering machine by speaking into a microphone 358 in the remote control unit 200. The outgoing message can be saved in a file in the remote control unit 200 and then sent via the wireless LAN to the set-top-box 100. Then the set-top-box 100 can send the file to the telephone answering machine and install the file in telephone answering machine. Then, when the phone rings, the caller will hear the newly recorded outgoing message. The user can do all this without even getting up from the couch.

As shown in FIG. 6, the user can speak into the microphone 358, and can listen to the speaker 359. In this way, the user can use the remote control unit 200 as a telephone handset. When a caller outside the home calls the home telephone 1 (316), a user can answer the home telephone 1 (316) without getting up from the couch, because the user can use the remote control unit 200 as a telephone handset and answer the incoming call. The user can also make outgoing calls from the remote control unit 200.

Additional advantages of the main control unit 100 and the remote control unit 200 are described below. When several remote control units 200 are used in a home with several family members, and the those family members are in different rooms of the house, those family members can speak to each other using the remote control units 200 because of the microphone 358 and speaker 359 on each one of the remote control units 200.

A user can plug a mobile telephone into an interface of the main control unit 100 when the user gets home. Then, when someone calls the mobile telephone and the user is at home, the user can answer the call using the remote control unit 200.

A user can plug a portable computer, such as a personal digital assistant (PDA) with an address book and with calendar functions, into an interface of the main control unit 100 when the user gets home. Then the user can access the features of the personal digital assistant wirelessly through the remote control unit 200. In this way, the user only needs to hold one device when the user is at home.

A user can use the display unit 250 and command input unit 220 of the remote control unit 200 to access the Internet 400 to read electronic mail (e-mail), send and receive e-mail, send and receive text messages, and perform instant messaging functions.

A user can use the remote control unit 200 to access the Internet 400 in order to gather information such as news, sports scores, weather, and any other information available on the Internet 400. The information that is available on the Internet 400 can be either displayed on a device such as the DTV1 (314), or can be displayed on the display unit 250, for example.

A user can use the speaker 359 of the remote control unit 200 to listen to digital music stored in a file. The file can be stored in memory 240, in memory 160, or on a disc inserted into the audio/video equipment AV3 (333), for example. Also, the user can plug headphones (not shown) into a connector (not shown) on the remote control unit 200 in order to listen to the music.

A user can watch movies using the remote control unit 200. For example, the user can cause a movie to be displayed on the display unit 250 or on the DTV1 (314) for example. In this case, the movie can in a file. The file can be stored in memory 240, in memory 160, or on a disc inserted into the audio/video equipment AV3 (333), for example.

The remote control unit 200, with speaker 359 and microphone 358, can be used for telephone communication by accessing the telephone 1 (316). In this case, the remote control unit 200 can be used to make and receive telephone calls, can be used to call a restaurant to order pizza, and can be used to order a pay-per-view movie, for example. The remote control unit 200 can be used to order a pay-per-view movie through the main control unit 100, Internet 400, and video on demand (VOD) server 410.

The remote control unit 200 can be used to play video games displayed on DTV1 (314), for example. In this case, the “Enter” key 352 can be pressed when the user wants to fire a missile as part of the video game, for example. The remote control unit 200 can also be used to play a video game that is displayed on the display unit 250, for example. The video game software could be stored in a file. The file can be stored in memory 240, in memory 160, or on a disc inserted into the audio/video equipment AV3 (333), for example.

The remote control unit 200 can perform video phone functions. For example, when a video phone call is performed, the user can speak to the other party by speaking into the microphone 358, the user can hear the other party by listening to speaker 359, and the user can view the other party by looking at the image displayed on the display unit 250. Also, the user can view the other party by looking at the image displayed on DTV1 (314), for example.

While the invention has been described in conjunction with various embodiments, they are illustrative only. Accordingly, many alternative, modifications and variations will be apparent to persons skilled in the art in light of the foregoing detailed description. The foregoing description illustrates some alternatives and variations falling with the spirit and broad scope of the appended claims. While the present invention has been illustrated by the description of embodiments thereof, and while the embodiments have been described in considerable detail, it is not the intention of the applicants to restrict or in anyway limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departing from the spirit and scope of the applicant's general inventive concept.

What is claimed is:

1. A main control unit for a home network system, the main control unit comprising:
a communication interface communicating with at least one device;
a wireless interface communicating wirelessly with a remote control unit, the remote control unit being separately located from-the main control unit; and
a controller receiving control signals from the remote control unit through said wireless interface, said controller controlling the at least one device through said communication interface in dependence upon the control signals.

2. The main control unit of claim 1, said communication interface performing the communicating with the at least one device through at least one selected from among a wireless network and a wire network.

3. The main control unit of claim 1, said wireless interface communicating with the remote control unit through a wireless local area network.

4. The main control unit of claim 1, with the main control unit corresponding to a set-top-box.

5. The main control unit of claim 1, with said communication interface corresponding to at least one selected from among a wireless local area network interface, an Institute of Electrical and Electronics Engineers 1394 interface, a Home Phone Network Alliance interface, and a power line communication interface.

6. The main control unit of claim 1, with said controller receiving a control result signal from the at least one device through said communication interface, and transmitting the control result signal to the remote control unit through said wireless interface.

7. A remote control unit for a home network system, the remote control unit comprising:
a wireless interface communicating wirelessly with a main control unit;
a command input unit inputting a command to control at least one device in communication with the main control unit; and
a controller transmitting a wireless control signal to the main control unit through said wireless interface to control the at least one device in dependence upon the command inputted at said command input unit.

8. The remote control unit of claim 7, further comprising:
an infrared interface performing infrared communication with the at least one device when the at least one device is within a predetermined distance of the remote control unit, said controller transmitting an infrared control signal corresponding to the command to the at least one device through said infrared interface.

9. The remote control unit of claim 7, further comprising:
a display unit displaying screen information for controlling the at least one device, said controller providing the screen information to said display unit in a form of a graphical user interface.

10. The remote control unit of claim 7, with said command input unit including a keypad.

11. The remote control unit of claim 7, with said command input unit including a touch sensitive screen.

12. The remote control unit of claim 7, with said controller receiving a first control result signal of the at least one device from the main control unit in response to the wireless control signal, said controller sensing whether the command was properly executed, the sensing being performed in dependence upon the first control result signal.

13. The remote control unit of claim 12, further comprising:
an infrared interface performing infrared communication with the at least one device when the at least one device is within a predetermined distance of the remote control unit, said controller transmitting an infrared control signal corresponding to the command to the at least one device through said infrared interface, said controller receiving a second control result signal of the at least one device from the at least one device through said infrared interface in response to the infrared control signal, said controller sensing whether the command was properly executed, the sensing being performed in dependence upon the second control result signal.

14. The remote control unit of claim 13, with said controller waiting to receive the second control result signal from the at least one device through said infrared interface for a predetermined quantity of time, said controller receiving the second control result signal from the main control unit through said wireless interface when the second control result signal is not received by said controller through said infrared interface before the predetermined quantity of time elapses, said controller sensing whether the command was properly executed, the sensing being performed in dependence upon the second control result signal.

15. The remote control unit of claim 13, with said controller waiting to receive the second control result signal from the at least one device through said infrared interface for a predetermined quantity of time, said controller transmitting a control result request signal to the main control unit through said wireless interface when the second control result signal is not received by said controller through said infrared interface before the predetermined quantity of time elapses, said controller receiving the second control result signal from the main control unit through said wireless interface, said controller sensing whether the command was properly executed, the sensing being performed in dependence upon the second control result signal.

16. A home network system, comprising:
a remote control unit, comprising:
a first wireless interface communicating wirelessly;
a command input unit inputting a command to control at least one device; and
a first controller wirelessly transmitting a control signal through said first wireless interface, the control signal corresponding to the command; and
a main control unit being separately located from said remote control unit, said main control unit comprising:
a communication interface communicating with the at least one device;
a second wireless interface communicating wirelessly with said first wireless interface, said second wireless interface receiving the control signal from said first wireless interface; and
a second controller controlling the at least one device through said communication interface in dependence upon the control signal received at said second wireless interface.

17. The home network system of claim 16, said communication interface performing the communicating with the at least one device through at least one selected from among a wireless network and a wire network, said second controller receiving a control result signal from the at least one device through said communication interface, and transmitting the control result signal to said remote control unit through said second wireless interface.

18. The home network system of claim 16, with said communication interface corresponding to at least one selected from among a wireless local area network interface, an Institute of Electrical and Electronics Engineers 1394 interface, a Home Phone Network Alliance interface, and a power line communication interface.

19. The home network system of claim 16, said remote control unit further comprising:
an infrared interface performing infrared communication with the at least one device when the at least one device is within a predetermined distance of said remote control unit, said first controller transmitting an infrared control signal corresponding to the command to the at least one device through said infrared interface, said first controller receiving a control result signal of the at least one device from the at least one device through said infrared interface in response to the infrared control signal, said first controller sensing whether the command was properly executed, the sensing being performed in dependence upon the control result signal.

20. The home network system of claim 19, with said first controller waiting to receive the control result signal from the at least one device through said infrared interface for a predetermined quantity of time, said first controller receiving the control result signal from said main control unit through said first wireless interface when the control result signal is not received by said first controller through said infrared interface before the predetermined quantity of time elapses, said first controller sensing whether the command was properly executed, the sensing being performed in dependence upon the control result signal.
